(19) United States
(12) Patent Application Publication
(10) Pub. No.: US 2010/0085685 A1
(43) Pub. Date: Apr. 8, 2010

(54) Capacitor Anode Formed From a Powder Containing Coarse Agglomerates and Fine Agglomerates

(75) Inventor: Ian Pinwill, Devon (GB)

Correspondence Address: DORITY & MANNING, P.A., POST OFFICE BOX 1449, GREENVILLE, SC, 29602-1449, US

(73) Assignee: AVX CORPORATION, Myrtle Beach, SC (US)

(21) Appl. No.: 12/548,654

(22) Filed: Aug. 27, 2009

Related U.S. Application Data
(60) Provisional application No. 61/102,900, filed on Oct. 6, 2008.

(51) Int. Cl. H01G 9/00; B28B 1/00; H01B 1/02

(52) U.S. Cl. 361/523; 264/109; 252/512

(57) ABSTRACT

A pressed anode formed from an electrically conductive powder that contains a plurality of coarse agglomerates and fine agglomerates is provided. The fine agglomerates have an average size smaller than that of the coarse agglomerates so that the resulting powder contains two or more distinct particle sizes, i.e., a “bimodal” distribution. In this manner, the fine agglomerates can effectively occupy the pores defined between adjacent coarse agglomerates (“inter-agglomerate pores”). Through the occupation of the empty pores, the fine agglomerates can increase the apparent density of the resulting powder, which improves volumetric efficiency.

### RELATED APPLICATIONS

The present application claims priority to the provisional patent application having U.S. Ser. No. 61/102,900 filed on Oct. 6, 2008, which is hereby incorporated by reference in its entirety.

### BACKGROUND OF THE INVENTION

Tantalum capacitors have been a major contributor to the miniaturization of electronic circuits and have made possible the application of such circuits in extreme environments. In the drive for electronic miniaturization, however, extreme pressure remains to even further improve the volumetric efficiency (the product of capacitance (“C”) and working voltage (“V”), divided by the volume of the capacitor) of such capacitors. To date, enhanced volumetric efficiency has largely been achieved through the use of higher surface area powders with a high capacitance per gram. Another possibility, however, is to increase the pressed density of the powder. Unfortunately, the ability to infiltrate anodes in later processing steps becomes limited when they are pressed to densities greater than about 6.5 g/cm³. The present inventors believe that one reason for this difficulty is that agglomerates within the powder are fractured at high press densities such that their outer surfaces become crushed. It is believed that this, in turn, creates finer capillaries at the surfaces of the agglomerates than within the interior, which inhibits the ability of liquids used in the manufacture of the capacitor (e.g., anodizing solution, manganizing solution, etc.) to infiltrate the agglomerate pores through capillary action.

As such, a need currently exists for a pressed anode that is capable of achieving a high volumetric efficiency, and yet also able to be readily infiltrated with liquids in further processing steps.

### SUMMARY OF THE INVENTION

In accordance with one embodiment of the present invention, a capacitor anode is disclosed that comprises a porous, sintered pellet formed from a compacted electrically conductive powder. The powder comprises a plurality of coarse agglomerates and a plurality of fine agglomerates. At least a portion of the fine agglomerates occupy pores defined between adjacent coarse agglomerates. The ratio of the average size of the coarse agglomerates to the average size of the fine agglomerates is from about 10 to about 150.

In accordance with another embodiment of the present invention, a method for forming a capacitor anode is disclosed. The method comprises compacting an electrically conductive powder to form a pellet and sintering the pellet to form an anode. The powder comprises a plurality of coarse agglomerates and a plurality of fine agglomerates. At least a portion of the fine agglomerates occupy pores defined between adjacent coarse agglomerates, and wherein the ratio of the average size of the coarse agglomerates to the average size of the fine agglomerates is from about 10 to about 150.

Other features and aspects of the present invention are set forth in greater detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 is a schematic illustration of one embodiment of the powder of the present invention, which contains a plurality of coarse agglomerates and fine agglomerates; and

FIG. 2 is a schematic illustration of one embodiment of a capacitor that may be formed in accordance with the present invention.

Repeat use of references characters in the present specification and drawings is intended to represent same or analogous features or elements of the invention.

### DETAILED DESCRIPTION OF REPRESENTATIVE EMBODIMENTS

It is to be understood by one of ordinary skill in the art that the present discussion is a description of exemplary embodiments only, and is not intended as limiting the broader aspects of the present invention, which broader aspects are embodied in the exemplary construction.

Generally speaking, the present invention is directed to a pressed anode formed from an electrically conductive powder that contains a plurality of coarse agglomerates and fine agglomerates. The agglomerates have a high specific charge, such as about 25,000 microFarads*Volts per gram (“μF*V/g”) or more, in some embodiments about 40,000 μF*V/g or more, in some embodiments about 60,000 μF*V/g or more, in some embodiments about 70,000 μF*V/g or more, and in some embodiments, about 80,000 to about 200,000 μF*V/g or more. Examples of compounds for forming such agglomerates include a valve metal (i.e., metal that is capable of oxidation) or valve metal-based compound, such as tantalum, niobium, aluminum, hafnium, titanium, alloys thereof, oxides thereof, nitrides thereof, and so forth. For example, the valve metal composition may contain an electrically conductive oxide of niobium, such as niobium oxide having an atomic ratio of niobium to oxygen of 1:1.0±1.0, in some embodiments 1:1.0±0.3, in some embodiments 1:1.0±0.1, and in some embodiments, 1:1.0±0.05. For example, the niobium oxide may be NbO_{0.7}, NbO_{1.0}, NbO_{1.1}, and NbO₂. In a preferred embodiment, the composition contains NbO_{1.0}, which is a conductive niobium oxide that may remain chemically stable even after sintering at high temperatures. Examples of such valve metal oxides are described in U.S. Pat. Nos. 6,322,912 to Fife; 6,391,275 to Fife et al.; 6,416,730 to Fife et al.; 6,527,937 to Fife; 6,576,099 to Kimmel, et al.; 6,592,740 to Fife, et al.; and 6,639,787 to Kimmel, et al.; and 7,220,397 to Kimmel, al., as well as U.S. Patent Application Publication Nos. 2005/0019581 to Schnitter; 2005/0103638 to Schnitter, et al.; 2005/0013765 to Thomas, et al., all of which are incorporated herein in their entirety by reference thereto for all purposes.

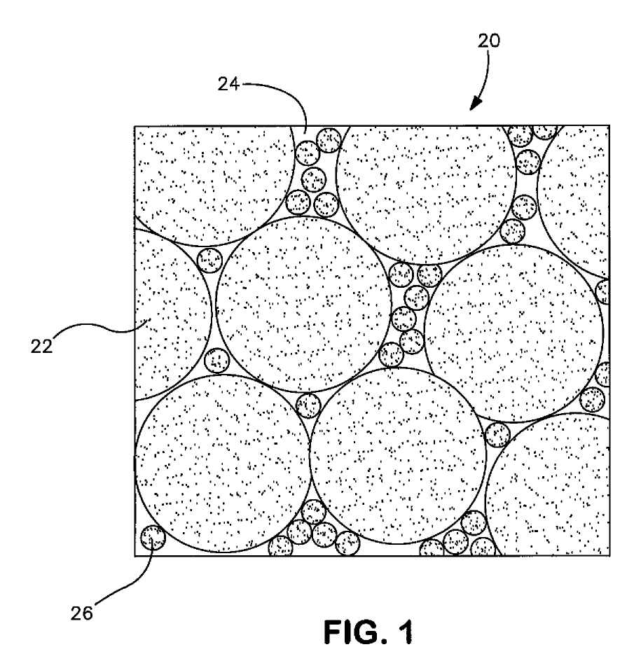

The fine agglomerates have an average size smaller than that of the coarse agglomerates so that the resulting powder contains two distinct particle sizes, i.e., a “bimodal” distribution. In this manner, the fine agglomerates can effectively occupy the pores defined between adjacent coarse agglomerates (“inter-agglomerate pores”). FIG. 1, for example, schematically illustrates one embodiment of a powder 20 that contains a plurality of fine agglomerates 26 occupying pores 24 between adjacent coarse agglomerates 22. Through the occupation of the empty pores 24, the fine agglomerates 26 can increase the apparent density of the powder 20, which improves volumetric efficiency. The apparent density (or Scott density) of such a powder, for instance, may range from about 1 to about 8 grams per cubic centimeter (g/cm³), in some embodiments from about 2 to about 7 g/cm³, and in some embodiments, from about 3 to about 6 g/cm³.

To achieve the desired level of packing and apparent density without adversely affecting other properties of the powder, the size and shape of the agglomerates are carefully controlled. For example, the shape of the agglomerates may be generally spherical, nodular, flake, etc. Although spherical agglomerates do not necessarily possess the ideal spatial arrangement for maximum packing efficiency, they have low inter-particle friction that may aid considerably in the attainment of higher densities. The ratio of the average size of the coarse agglomerates to the average size of the fine agglomerates may also be relatively large, such as from about 10 to about 150, in some embodiments from about 15 to about 125, in some embodiments from about 20 to about 100, and in some embodiments, from about 30 to about 75. In certain embodiments, the coarse agglomerates have an average size of from about 20 to about 250 micrometers, in some embodiments from about 30 to about 150 micrometers, and in some embodiments, from about 40 to about 100 micrometers. Likewise, the fine agglomerates may have an average size of from about 0.1 to about 20 micrometers, in some embodiments from about 0.5 to about 15 micrometers, and in some embodiments, from about 1 to about 10 micrometers.

The coarse and fine agglomerates may be formed using techniques known to those skilled in the art. A precursor tantalum powder, for instance, may be formed by reducing a tantalum salt (e.g., potassium fluotantalate (K₂TaF₇), sodium fluotantalate (Na₂TaF₇), tantalum pentachloride (TaCl₅), etc.) with a reducing agent (e.g., hydrogen, sodium, potassium, magnesium, calcium, etc.). Such powders may be agglomerated in a variety of ways, such as through one or multiple heat treatment steps at a temperature of from about 700° C. to about 1400° C., in some embodiments from about 750° C. to about 1200° C., and in some embodiments, from about 800° C. to about 1100° C. Heat treatment may occur in an inert or reducing atmosphere. For example, heat treatment may occur in an atmosphere containing hydrogen or a hydrogen-releasing compound (e.g., ammonium chloride, calcium hydride, magnesium hydride, etc.) to partially sinter the powder and decrease the content of impurities (e.g., fluorine). If desired, agglomeration may also be performed in the presence of a getter material, such as magnesium. After thermal treatment, the highly reactive coarse agglomerates may be passivated by gradual admission of air. Other suitable agglomeration techniques are also described in U.S. Pat. Nos. 6,576,038 to Rao; 6,238,456 to Wolf, et al.; 5,954,856 to Pathare, et al.; 5,082,491 to Rerat; 4,555,268 to Getz; 4,483,819 to Albrecht, et al.; 4,441,927 to Getz, et al.; and 4,017,302 to Bates, et al., which are incorporated herein in their entirety by reference thereto for all purposes.

The desired size and/or shape of the coarse and fine agglomerates may be achieved by simply controlling various processing parameters as is known in the art, such as the parameters relating to powder formation (e.g., reduction process) and/or agglomeration (e.g., temperature, atmosphere, etc.). Milling techniques may also be employed to grind a precursor powder to the desired size. Any of a variety of milling techniques may be utilized to achieve the desired particle characteristics. For example, the powder may initially be dispersed in a fluid medium (e.g., ethanol, methanol, fluorinated fluid, etc.) to form a slurry. The slurry may then be combined with a grinding media (e.g., metal balls, such as tantalum) in a mill. The number of grinding media may generally vary depending on the size of the mill, such as from about 100 to about 2000, and in some embodiments from about 600 to about 1000. The starting powder, the fluid medium, and grinding media may be combined in any proportion. For example, the ratio of the starting powder to the grinding media may be from about 1:5 to about 1:50. Likewise, the ratio of the volume of the fluid medium to the combined volume of the starting powder may be from about 0.5:1 to about 3:1, in some embodiments from about 0.5:1 to about 2:1, and in some embodiments, from about 0.5:1 to about 1:1. Some examples of mills that may be used in the present invention are described in U.S. Pat. Nos. 5,522,558; 5,232,169; 6,126,097; and 6,145,765, which are incorporated herein in their entirety by reference thereto for all purposes. Milling may occur for any predetermined amount of time needed to achieve the target size. For example, the milling time may range from about 30 minutes to about 40 hours, in some embodiments, from about 1 hour to about 20 hours, and in some embodiments, from about 5 hours to about 15 hours. Milling may be conducted at any desired temperature, including at room temperature or an elevated temperature. After milling, the fluid medium may be separated or removed from the powder, such as by air-drying, heating, filtering, evaporating, etc.

Any technique may be employed to blend the fine agglomerates with the coarse agglomerates. For example, in certain embodiments, the fine agglomerates are simply dry blended with the coarse agglomerates. Regardless of the manner in which they are combined, the weight fraction of the coarse agglomerates and fine agglomerates is typically controlled to achieve a balance between good flowability and volumetric efficiency. For example, the weight fraction of the coarse agglomerates may range from about 50 wt. % to about 90 wt. %, in some embodiments from about 60 wt. % to about 80 wt. %, and in some embodiments, from about 65 wt. % to about 75 wt. % of the powder. Likewise, the weight fraction of the fine agglomerates may range from about 10 wt. % to about 50 wt. %, in some embodiments from about 20 wt. % to about 40 wt. %, and in some embodiments, from about 25 wt. % to about 35 wt. % of the powder.

Various other conventional treatments may also be employed in the present invention to improve the properties of the powder. Such treatments may be employed before and/or after combination of the fine agglomerates with the coarse agglomerates. For example, in certain embodiments, the fine agglomerates and/or coarse agglomerates may be doped with sinter retardants in the presence of a dopant, such as aqueous acids (e.g., phosphoric acid). The amount of the dopant added depends in part on the surface area of the powder, but is typically present in an amount of no more than about 200 parts per million (“ppm”). The dopant may be added prior to, during, and/or subsequent to any heat treatment step(s).

The fine agglomerates and/or coarse agglomerates may also be subjected to one or more deoxidation treatments to improve ductility and reduce leakage current in the anodes. For example, the fine agglomerates and/or coarse agglomerates may be exposed to a getter material (e.g., magnesium), such as described in U.S. Pat. No. 4,960,471, which is incorporated herein in its entirety by reference thereto for all purposes. The getter material may be present in an amount of from about 2% to about 6% by weight. The temperature at which deoxidation occurs may vary, but typically ranges from about 700° C. to about 1600° C., in some embodiments from about 750° C. to about 1200° C., and in some embodiments, from about 800° C. to about 1000° C. The total time of deoxidation treatment(s) may range from about 20 minutes to about 3 hours. Deoxidation also preferably occurs in an inert atmosphere (e.g., argon). Upon completion of the deoxidation treatment(s), the magnesium or other getter material typically vaporizes and forms a precipitate on the cold wall of the furnace. To ensure removal of the getter material, however, the fine agglomerates and/or coarse agglomerates may be subjected to one or more acid leaching steps, such as with nitric acid, hydrofluoric acid, etc.

To facilitate the construction of the anode, certain components may also be included in the powder. For example, the powder may be optionally mixed with a binder and/or lubricant to ensure that the particles adequately adhere to each other when pressed to form the anode body. Suitable binders may include, for instance, poly(vinyl butyral); poly(vinyl acetate); poly(vinyl alcohol); poly(vinyl pyrollidone); cellulosic polymers, such as carboxymethylcellulose, methyl cellulose, ethyl cellulose, hydroxyethyl cellulose, and methylhydroxyethyl cellulose; atactic polypropylene, polyethylene; polyethylene glycol (e.g., Carbowax from Dow Chemical Co.); polystyrene, poly(butadiene/styrene); polyamides, polyimides, and polyacrylamides, high molecular weight polyethers; copolymers of ethylene oxide and propylene oxide; fluoropolymers, such as polytetrafluoroethylene, polyvinylidene fluoride, and fluoro-olefin copolymers; acrylic polymers, such as sodium polyacrylate, poly(lower alkyl acrylates), poly(lower alkyl methacrylates) and copolymers of lower alkyl acrylates and methacrylates; and fatty acids and waxes, such as stearic and other soapy fatty acids, vegetable wax, microwaxes (purified paraffins), etc. The binder may be dissolved and dispersed in a solvent. Exemplary solvents may include water, alcohols, and so forth. When utilized, the percentage of binders and/or lubricants may vary from about 0.1% to about 8% by weight of the total mass. It should be understood, however, that binders and/or lubricants are not necessarily required in the present invention.

The resulting powder may be compacted to form a pellet using any conventional powder press device. For example, a press mold may be employed that is a single station compaction press containing a die and one or multiple punches. Alternatively, anvil-type compaction press molds may be used that use only a die and single lower punch. Single station compaction press molds are available in several basic types, such as cam, toggle/knuckle and eccentric/crank presses with varying capabilities, such as single action, double action, floating die, movable platen, opposed ram, screw, impact, hot pressing, coining or sizing. The powder may be compacted around an anode lead (e.g., tantalum wire). It should be further appreciated that the anode lead may alternatively be attached (e.g., welded) to the anode body subsequent to pressing and/or sintering of the anode body.

After compaction, any binder/lubricant may be removed by heating the pellet under vacuum at a certain temperature (e.g., from about 150° C. to about 500° C.) for several minutes. Alternatively, the binder/lubricant may also be removed by contacting the pellet with an aqueous solution, such as described in U.S. Pat. No. 6,197,252 to Bishop, et al., which is incorporated herein in its entirety by reference thereto for all purposes. Thereafter, the pellet is sintered to form a porous, integral mass. For example, in one embodiment, the pellet may be sintered at a temperature of from about 1200° C. to about 2000° C., and in some embodiments, from about 1500° C. to about 1800° C. under vacuum or an inert atmosphere. Upon sintering, the pellet shrinks due to the growth of bonds between the particles. Due to the bimodal particle distribution employed in the powder, the present inventors believe that lower press densities may be employed to still achieve the desired target volumetric efficiency. For example, the press density of the pellet after sintering is typically from about 4.0 to about 7.0 grams per cubic centimeter, in some embodiments from about 4.5 to about 6.5, and in some embodiments, from about 4.5 to about 6.0 grams per cubic centimeter. The pressed density is determined by dividing the amount of material by the volume of the pressed pellet.

In addition to the techniques described above, any other technique for constructing the anode may also be utilized in accordance with the present invention, such as described in U.S. Pat. Nos. 4,085,435 to Galvagni; 4,945,452 to Sturmer, et al.; 5,198,968 to Galvagni; 5,357,399 to Salisbury; 5,394,295 to Galvagni, et al.; 5,495,386 to Kulkarni; and 6,322,912 to Fife, which are incorporated herein in their entirety by reference thereto for all purposes.

Although not required, the thickness of the anode may be selected to improve the electrical performance of the capacitor. For example, the thickness of the anode may be about 4 millimeters or less, in some embodiments, from about 0.05 to about 2 millimeters, and in some embodiments, from about 0.1 to about 1 millimeter. The shape of the anode may also be selected to improve the electrical properties of the resulting capacitor. For example, the anode may have a shape that is curved, sinusoidal, rectangular, U-shaped, V-shaped, etc. The anode may also have a “fluted” shape in that it contains one or more furrows, grooves, depressions, or indentations to increase the surface to volume ratio to minimize ESR and extend the frequency response of the capacitance. Such “fluted” anodes are described, for instance, in U.S. Pat. Nos. 6,191,936 to Webber, et al.; 5,949,639 to Maeda, et al.; and 3,345,545 to Bourgault et al., as well as U.S. Patent Application Publication No. 2005/0270725 to Hahn, et al., all of which are incorporated herein in their entirety by reference thereto for all purposes.

Once constructed, the anode may be anodized so that a dielectric layer is formed over and/or within the anode. Anodization is an electrochemical process by which the anode is oxidized to form a material having a relatively high dielectric constant. For example, a tantalum anode may be anodized to tantalum pentoxide (Ta₂O₅). Typically, anodization is performed by initially applying an electrolyte to the anode, such as by dipping anode into the electrolyte. The electrolyte is generally in the form of a liquid, such as a solution (e.g., aqueous or non-aqueous), dispersion, melt, etc. A solvent is generally employed in the electrolyte, such as water (e.g., deionized water); ethers (e.g., diethyl ether and tetrahydrofuran); alcohols (e.g., methanol, ethanol, n-propanol, isopropanol, and butanol); triglycerides; ketones (e.g., acetone, methyl ethyl ketone, and methyl isobutyl ketone); esters (e.g., ethyl acetate, butyl acetate, diethylene glycol ether acetate, and methoxypropyl acetate); amides (e.g., dimethylformamide, dimethylacetamide, dimethylcaprylic/capric fatty acid amide and N-alkylpyrrolidones); nitriles (e.g., acetonitrile, propionitrile, butyronitrile and benzonitrile); sulfoxides or sulfones (e.g., dimethyl sulfoxide (DMSO) and sulfolane); and so forth. The solvent may constitute from about 50 wt. % to about 99.9 wt. %, in some embodiments from about 75 wt. % to about 99 wt. %, and in some embodiments, from about 80 wt. % to about 95 wt. % of the electrolyte. Although not necessarily required, the use of an aqueous solvent (e.g., water) is often desired to help achieve the desired oxide. In fact, water may constitute about 50 wt. % or more, in some embodiments, about 70 wt. % or more, and in some embodiments, about 90 wt. % to 100 wt. % of the solvent(s) used in the electrolyte.

The electrolyte is ionically conductive and may have an ionic conductivity of about 1 milliSiemens per centimeter (“mS/cm”) or more, in some embodiments about 30 mS/cm or more, and in some embodiments, from about 40 mS/cm to about 100 mS/cm, determined at a temperature of 25° C. To enhance the ionic conductivity of the electrolyte, a compound may be employed that is capable of dissociating in the solvent to form ions. Suitable ionic compounds for this purpose may include, for instance, acids, such as hydrochloric acid, nitric acid, sulfuric acid, phosphoric acid, polyphosphoric acid, boric acid, boronic acid, etc.; organic acids, including carboxylic acids, such as acrylic acid, methacrylic acid, malonic acid, succinic acid, salicylic acid, sulfosalicylic acid, adipic acid, maleic acid, malic acid, oleic acid, gallic acid, tartaric acid, citric acid, formic acid, acetic acid, glycolic acid, oxalic acid, propionic acid, phthalic acid, isophthalic acid, glutaric acid, gluconic acid, lactic acid, aspartic acid, glutaminic acid, itaconic acid, trifluoroacetic acid, barbituric acid, cinnamic acid, benzoic acid, 4-hydroxybenzoic acid, aminobenzoic acid, etc.; sulfonic acids, such as methanesulfonic acid, benzenesulfonic acid, toluenesulfonic acid, trifluoromethanesulfonic acid, styrenesulfonic acid, naphthalene disulfonic acid, hydroxybenzenesulfonic acid, dodecylsulfonic acid, dodecylbenzenesulfonic acid, etc.; polymeric acids, such as poly(acrylic) or poly(methacrylic) acid and copolymers thereof (e.g., maleic-acrylic, sulfonic-acrylic, and styrene-acrylic copolymers), carageenic acid, carboxymethyl cellulose, alginic acid, etc.; and so forth. The concentration of ionic compounds is selected to achieve the desired ionic conductivity. For example, an acid (e.g., phosphoric acid) may constitute from about 0.01 wt. % to about 5 wt. %, in some embodiments from about 0.05 wt. % to about 0.8 wt. %, and in some embodiments, from about 0.1 wt. % to about 0.5 wt. % of the electrolyte. If desired, blends of ionic compounds may also be employed in the electrolyte.

A current is passed through the electrolyte to form the dielectric layer. The value of voltage manages the thickness of the dielectric layer. For example, the power supply may be initially set up at a galvanostatic mode until the required voltage is reached. Thereafter, the power supply may be switched to a potentiostatic mode to ensure that the desired dielectric thickness is formed over the surface of the anode. Of course, other known methods may also be employed, such as pulse or step potentiostatic methods. The voltage typically ranges from about 4 to about 200 V, and in some embodiments, from about 9 to about 100 V. During anodic oxidation, the electrolyte can be kept at an elevated temperature, such as about 30° C. or more, in some embodiments from about 40° C. to about 200° C., and in some embodiments, from about 50° C. to about 100° C. Anodic oxidation can also be done at ambient temperature or lower. The resulting dielectric layer may be formed on a surface of the anode and within its pores.

Once the dielectric layer is formed, a protective coating may optionally be applied, such as one made of a relatively insulative resinous material (natural or synthetic). Such materials may have a specific resistivity of greater than about 10 Ω/cm, in some embodiments greater than about 100, in some embodiments greater than about 1,000 Ω/cm, in some embodiments greater than about 1×10⁵ Ω/cm, and in some embodiments, greater than about 1×10¹⁰ Ω/cm. Some resinous materials that may be utilized in the present invention include, but are not limited to, polyurethane, polystyrene, esters of unsaturated or saturated fatty acids (e.g., glycerides), and so forth. For instance, suitable esters of fatty acids include, but are not limited to, esters of lauric acid, myristic acid, palmitic acid, stearic acid, eleostearic acid, oleic acid, linoleic acid, linolenic acid, aleuritic acid, shellolic acid, and so forth. These esters of fatty acids have been found particularly useful when used in relatively complex combinations to form a “drying oil”, which allows the resulting film to rapidly polymerize into a stable layer. Such drying oils may include mono-, di-, and/or tri-glycerides, which have a glycerol backbone with one, two, and three, respectively, fatty acyl residues that are esterified. For instance, some suitable drying oils that may be used include, but are not limited to, olive oil, linseed oil, castor oil, flung oil, soybean oil, and shellac. These and other protective coating materials are described in more detail U.S. Pat. No. 6,674,635 to Fife, et al., which is incorporated herein in its entirety by reference thereto for all purposes.

The anodized part may thereafter be subjected to a step for forming a cathode that includes a solid electrolyte, such as a manganese dioxide, conductive polymer, etc. A manganese dioxide solid electrolyte may, for instance, be formed by the pyrolytic decomposition of manganous nitrate (Mn(NO₃)₂). Such techniques are described, for instance, in U.S. Pat. No. 4,945,452 to Sturmer, et al., which is incorporated herein in its entirety by reference thereto for all purposes. Alternatively, a conductive polymer coating may be employed that contains one or more polyheterocycles (e.g., polypyrroles; polythiophenes, poly(3,4-ethylenedioxythiophene) (PEDT); polyanilines); polyacetylenes; poly-p-phenylenes; polyphenolates; and derivatives thereof. Moreover, if desired, the conductive polymer coating may also be formed from multiple conductive polymer layers. For example, in one embodiment, the conductive polymer cathode may contain one layer formed from PEDT and another layer formed from a polypyrrole. Various methods may be utilized to apply the conductive polymer coating onto the anode part. For instance, conventional techniques such as electropolymerization, screen-printing, dipping, electrophoretic coating, and spraying, may be used to form a conductive polymer coating. In one embodiment, for example, the monomer(s) used to form the conductive polymer (e.g., 3,4-ethylenedioxy-thiophene) may initially be mixed with a polymerization catalyst to form a solution. For example, one suitable polymerization catalyst is CLEVIOS C, which is iron III toluene-sulfonate and sold by H. C. Starck. CLEVIOS C is a commercially available catalyst for CLEVIOS M, which is 3,4-ethylene dioxythiophene, a PEDT monomer also sold by H. C. Starck. Once a catalyst dispersion is formed, the anode part may then be dipped into the dispersion so that the polymer forms on the surface of the anode part. Alternatively, the catalyst and monomer(s) may also be applied separately to the anode part. In one embodiment, for example, the catalyst may be dissolved in a solvent (e.g., butanol) and then applied to the anode part as a dipping solution. The anode part may then be dried to remove the solvent therefrom. Thereafter, the anode part may be dipped into a solution containing the appropriate monomer. Once the monomer contacts the surface of the anode part containing the catalyst, it chemically polymerizes thereon. In addition, the catalyst (e.g., CLEVIOS C) may also be mixed with the material(s) used to form the optional protective coating (e.g., resinous materials). In such instances, the anode part may then be dipped into a solution containing the monomer (CLEVIOS M). As a result, the monomer can contact the catalyst within and/or on the surface of the protective coating and react therewith to form the conductive polymer coating. Although various methods have been described above, it should be understood that any other method for applying the conductive coating(s) to the anode part may also be utilized in the present invention. For example, other methods for applying such conductive polymer coating(s) may be described in U.S. Pat. Nos. 5,457,862 to Sakata, et al., 5,473,503 to Sakata, et al., 5,729,428 to Sakata, et al., and 5,812,367 to Kudoh, et al., which are incorporated herein in their entirety by reference thereto for all purposes.

In most embodiments, once applied, the solid electrolyte is healed. Healing may occur after each application of a solid electrolyte layer or may occur after the application of the entire coating. In some embodiments, for example, the solid electrolyte may be healed by dipping the pellet into an electrolyte solution, such as a solution of phosphoric acid and/or sulfuric acid, and thereafter applying a constant voltage to the solution until the current is reduced to a preselected level. If desired, such healing may be accomplished in multiple steps. For instance, in one embodiment, a pellet having a conductive polymer coating is first dipped in phosphoric acid and applied with about 20 Volts and then dipped in sulfuric acid and applied with about 2 Volts. In this embodiment, the use of the second low voltage sulfuric acid solution or toluene sulfonic acid can help increase capacitance and reduce the dissipation factor (DF) of the resulting capacitor. After application of some or all of the layers described above, the pellet may then be washed if desired to remove various byproducts, excess catalysts, and so forth. Further, in some instances, drying may be utilized after some or all of the dipping operations described above. For example, drying may be desired after applying the catalyst and/or after washing the pellet in order to open the pores of the pellet so that it can receive a liquid during subsequent dipping steps.

If desired, the part may optionally be applied with a carbon layer (e.g., graphite) and silver layer, respectively. The silver coating may, for instance, act as a solderable conductor, contact layer, and/or charge collector for the capacitor and the carbon coating may limit contact of the silver coating with the solid electrolyte. Such coatings may cover some or all of the solid electrolyte.

If desired, the capacitor may also be provided with terminations, particularly when employed in surface mounting applications. For example, the capacitor may contain an anode termination to which the anode lead of the capacitor element is electrically connected and a cathode termination to which the cathode of the capacitor element is electrically connected. Any conductive material may be employed to form the terminations, such as a conductive metal (e.g., copper, nickel, silver, nickel, zinc, tin, palladium, lead, copper, aluminum, molybdenum, titanium, iron, zirconium, magnesium, and alloys thereof). Particularly suitable conductive metals include, for instance, copper, copper alloys (e.g., copper-zirconium, copper-magnesium, copper-zinc, or copper-iron), nickel, and nickel alloys (e.g., nickel-iron). The thickness of the terminations is generally selected to minimize the thickness of the capacitor. For instance, the thickness of the terminations may range from about 0.05 to about 1 millimeter, in some embodiments from about 0.05 to about 0.5 millimeters, and from about 0.07 to about 0.2 millimeters. One exemplary conductive material is a copper-iron alloy metal plate available from Wieland (Germany). If desired, the surface of the terminations may be electroplated with nickel, silver, gold, tin, etc. as is known in the art to ensure that the final part is mountable to the circuit board. In one particular embodiment, both surfaces of the terminations are plated with nickel and silver flashes, respectively, while the mounting surface is also plated with a tin solder layer.

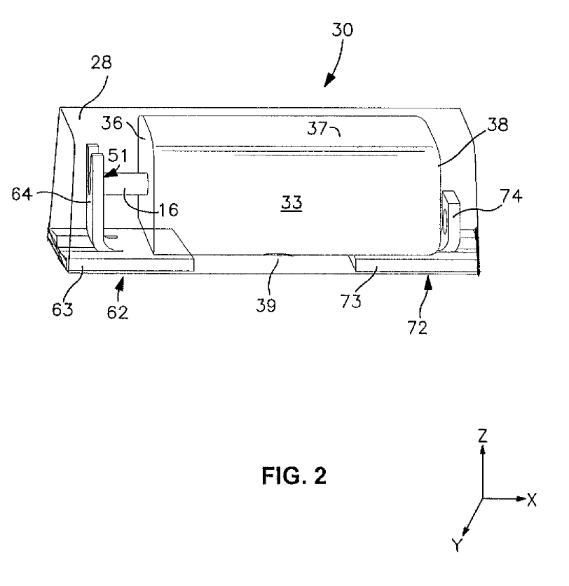

Referring to FIG. 2, one embodiment of an electrolytic capacitor 30 is shown that includes an anode termination 62 and a cathode termination 72 in electrical connection with a capacitor element 33. The capacitor element 33 has an upper surface 37, lower surface 39, front surface 36, and rear surface 38. Although it may be in electrical contact with any of the surfaces of the capacitor element 33, the cathode termination 72 in the illustrated embodiment is in electrical contact with the lower surface 39 and rear surface 38. More specifically, the cathode termination 72 contains a first component 73 positioned substantially perpendicular to a second component 74. The first component 73 is in electrical contact and generally parallel with the lower surface 39 of the capacitor element 33. The second component 74 is in electrical contact and generally parallel to the rear surface 38 of the capacitor element 33. Although depicted as being integral, it should be understood that these portions may alternatively be separate pieces that are connected together, either directly or via an additional conductive element (e.g., metal).

The anode termination 62 likewise contains a first component 63 positioned substantially perpendicular to a second component 64. The first component 63 is in electrical contact and generally parallel with the lower surface 39 of the capacitor element 33. The second component 64 contains a region 51 that carries an anode lead 16. In the illustrated embodiment, the region 51 possesses a “U-shape” for further enhancing surface contact and mechanical stability of the lead 16.

The terminations may be connected to the capacitor element using any technique known in the art. In one embodiment, for example, a lead frame may be provided that defines the cathode termination 72 and anode termination 62. To attach the electrolytic capacitor element 33 to the lead frame, a conductive adhesive may initially be applied to a surface of the cathode termination 72. The conductive adhesive may include, for instance, conductive metal particles contained with a resin composition. The metal particles may be silver, copper, gold, platinum, nickel, zinc, bismuth, etc. The resin composition may include a thermoset resin (e.g., epoxy resin), curing agent (e.g., acid anhydride), and coupling agent (e.g., silane coupling agents). Suitable conductive adhesives may be described in U.S. Patent Application Publication No. 2006/0038304 to Osako et al., which is incorporated herein in its entirety by reference thereto for all purposes. Any of a variety of techniques may be used to apply the conductive adhesive to the cathode termination 72. Printing techniques, for instance, may be employed due to their practical and cost-saving benefits.

A variety of methods may generally be employed to attach the terminations to the capacitor. In one embodiment, for example, the second component 64 of the anode termination 62 and the second component 74 of the cathode termination 72 are initially bent upward to the position shown in FIG. 2. Thereafter, the capacitor element 33 is positioned on the cathode termination 72 so that its lower surface 39 contacts the adhesive and the anode lead 16 is received by the upper U-shaped region 51. If desired, an insulating material (not shown), such as a plastic pad or tape, may be positioned between the lower surface 39 of the capacitor element 33 and the first component 63 of the anode termination 62 to electrically isolate the anode and cathode terminations.

The anode lead 16 is then electrically connected to the region 51 using any technique known in the art, such as mechanical welding, laser welding, conductive adhesives, etc. For example, the anode lead 16 may be welded to the anode termination 62 using a laser. Lasers generally contain resonators that include a laser medium capable of releasing photons by stimulated emission and an energy source that excites the elements of the laser medium. One type of suitable laser is one in which the laser medium consist of an aluminum and yttrium garnet (YAG), doped with neodymium (Nd). The excited particles are neodymium ions Nd³⁺. The energy source may provide continuous energy to the laser medium to emit a continuous laser beam or energy discharges to emit a pulsed laser beam. Upon electrically connecting the anode lead 16 to the anode termination 62, the conductive adhesive may then be cured. For example, a heat press may be used to apply heat and pressure to ensure that the electrolytic capacitor element 33 is adequately adhered to the cathode termination 72 by the adhesive.

Once the capacitor element is attached, the lead frame is enclosed within a resin casing, which may then be filled with silica or any other known encapsulating material. The width and length of the case may vary depending on the intended application. Suitable casings may include, for instance, “A”, “B”, “F”, “G”, “H”, “J”, “K”, “L”, “M”, “N”, “P”, “R”, “S”, “T”, “W”, “Y”, or “X” cases (AVX Corporation). Regardless of the case size employed, the capacitor element is encapsulated so that at least a portion of the anode and cathode terminations are exposed for mounting onto a circuit board. As shown in FIG. 2, for instance, the capacitor element 33 is encapsulated in a case 28 so that a portion of the anode termination 62 and a portion of the cathode termination 72 are exposed.

Regardless of the particular manner in which it is formed, the resulting capacitor may possess a high volumetric efficiency and also exhibit excellent electrical properties. Even at such high volumetric efficiencies, the equivalent series resistance (“ESR”) may still be less than about 300 milliohms, in some embodiments less than about 200 milliohms, and in some embodiments, less than about 100 milliohms, as measured with a 2-volt bias and 1-volt signal at a frequency of 2 MHz. The dissipation factor (DF) of the capacitor, which refers to losses that occur in the capacitor as a percentage of the ideal capacitor performance, may also be maintained at relatively low levels. For example, the dissipation factor of a capacitor of the present invention is typically less than about 10%, and in some embodiments, less than about 5%.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A capacitor anode comprising a porous, sintered pellet formed from a compacted powder that is electrically conductive, the powder comprising a plurality of coarse agglomerates and a plurality of fine agglomerates, wherein at least a portion of the fine agglomerates occupy pores defined between adjacent coarse agglomerates, wherein the ratio of the average size of the coarse agglomerates to the average size of the fine agglomerates is from about 10 to about 150.

2. The capacitor anode of claim 1, wherein the weight fraction of the coarse agglomerates is from about 50 wt. % to about 90 wt. % and the weight fraction of the fine agglomerates is from about 10 wt % to about 50 wt. % of the powder.

3. The capacitor anode of claim 1, wherein the weight fraction of the coarse agglomerates is from about 65 wt. % to about 75 wt. % and the weight fraction of the fine agglomerates is from about 25 wt. % to about 35 wt. % of the powder.

4. The capacitor anode of claim 1, wherein the powder has an apparent density of from about 1 to about 8 grams per cubic centimeter.

5. The capacitor anode of claim 1, wherein the powder has an apparent density of from about 3 to about 6 grams per cubic centimeter.

6. The capacitor anode of claim 1, wherein the ratio of the average size of the coarse agglomerates to the average size of the fine agglomerates is from about 20 to about 100.

7. The capacitor anode of claim 1, wherein the ratio of the average size of the coarse agglomerates to the average size of the fine agglomerates is from about 30 to about 75.

8. The capacitor anode of claim 1, wherein the average size of the coarse agglomerates is from about 20 to about 250 micrometers and the average size of the fine agglomerates is from about 0.1 to about 20 micrometers.

9. The capacitor anode of claim 1, wherein the average size of the coarse agglomerates is from about 40 to about 100 micrometers and the average size of the fine agglomerates is from about 1 to about 10 micrometers.

10. The capacitor anode of claim 1, wherein the coarse and fine agglomerates are formed from tantalum.

11. The capacitor anode of claim 10, wherein the coarse agglomerates and the fine agglomerates are formed from sodium-reduced tantalum powder, magnesium-reduced tantalum powder, or a combination thereof.

12. The capacitor anode of claim 1, wherein the press density of the pellet is from about 4.0 to about 7.0 grams per cubic centimeter.

13. A solid electrolytic capacitor comprising:
the anode of any of the foregoing claims;
a dielectric layer overlying the anode; and
a solid electrolyte layer overlying the dielectric layer.

14. The capacitor of claim 13, further comprising an anode lead that extends from the anode.

15. The solid electrolytic capacitor of claim 14, further comprising:
a cathode termination that is in electrical communication with the solid electrolyte layer;
an anode termination that is in electrical communication with the anode lead; and
a case that encapsulates the capacitor and leaves at least a portion of the anode and cathode terminations exposed.

16. The solid electrolytic capacitor of claim 13, wherein the solid electrolyte layer contains a conductive polymer.

17. The solid electrolytic capacitor of claim 13, wherein the solid electrolyte layer contains manganese dioxide.

18. A method for forming a capacitor anode, the method comprising:
compacting an electrically conductive powder to form a pellet, wherein the powder comprises a plurality of coarse agglomerates and a plurality of fine agglomerates, wherein at least a portion of the fine agglomerates occupy pores defined between adjacent coarse agglomerates, wherein the ratio of the average size of the coarse agglomerates to the average size of the fine agglomerates is from about 10 to about 150; and
sintering the pellet to form an anode.

19. The method of claim 18, further comprising mixing the powder with a binder prior to compaction.

20. The method of claim 18, wherein the pellet is sintered at a temperature of from about 1200° C. to about 2000° C.

21. The method of claim 18, wherein the press density of the sintered pellet is from about 4.0 to about 7.0 grams per cubic centimeter.

22. The method of claim 18, wherein an anode lead is embedded in the powder prior to compaction.
